(19) United States
(12) Patent Application Publication
(10) Pub. No.: US 2014/0082702 A1
(43) Pub. Date: Mar. 20, 2014

(54) SYSTEMS AND METHODS FOR CONTROLLING AND COMMUNICATING WITH CONNECTED DEVICES

(71) Applicant: Spark Devices, Minneapolis, MN (US)

(72) Inventor: Zachary Newport Supalla, Minneapolis, MN (US)

(73) Assignee: Spark Devices, Minneapolis, MN (US)

(21) Appl. No.: 14/029,179

(22) Filed: Sep. 17, 2013

Related U.S. Application Data
(60) Provisional application No. 61/702,883, filed on Sep. 19, 2012.

(51) Int. Cl. H04L 29/06

(52) U.S. Cl. CPC H04L 63/10
USPC 726/4

(57) ABSTRACT

Systems and methods for controlling and communicating with electronic devices (connected devices) remotely through an Internet connection or other networks are disclosed. In some embodiments, a system of connected devices includes appliances, consumer electronics products, sensors, or modules intended to control devices attached to the connected devices, such as, for example, light bulbs or other appliances, through power outlets or other electrical or mechanical connections. A remote server may be able to receive signals directly from a user via input from a user device, or from a third party, and communication from the user or from third parties may be secured such that only the user and the third parties given explicit permission can control and communicate with the connected devices belonging to the user.

### CLAIM OF PRIORITY

This application claims the benefit of priority to U.S. Provisional Patent Application Ser. No. 61/702,883, filed Sep. 19, 2012, which application is hereby incorporated by reference herein in its entirety.

### TECHNICAL FIELD

The present disclosure relates to systems and methods for controlling and communicating with electronic devices (also referred to as connected devices) remotely through an Internet connection or other networks.

### BACKGROUND

Home automation or automation of home, housework or household activities, has recently attracted much attention. Known home automation systems use communication technologies for centralized control of lighting, HVAC (heating, ventilation and air conditioning), appliances and other systems to provide improved convenience, comfort, energy efficiency and security. Currently existing home automation systems, however, typically use communication technologies such as, for example, X10, Zigbee, Z-Wave, etc., which often lack reliability. These home automation systems often require installation by a contractor or licensed electrician. Moreover, such home automation systems typically only allow for local communication, meaning that communication can occur within a home, but not from locations outside the home. In known systems, communication is usually limited to compatible devices that use the same communication technology. The process for setting up known home automation devices is usually complicated, often due to challenges of the underlying communication technologies. Furthermore, communication is generally intended to only occur by direct intervention of a user, rather than through third party services such as, for example, software applications. Therefore, there is no method for allowing third parties to access the devices in a secure way.

There is a need, therefore, for improved systems and methods for home automation and connected devices.

### SUMMARY

In some embodiments, a system of connected devices includes appliances, consumer electronics products, sensors, or modules intended to control devices attached to the connected devices, such as, for example, light bulbs or other appliances, through power outlets or other electrical or mechanical connections. These connected devices can communicate over a wireless network such as 802.11 (“Wi-Fi”), 802.15.4, or other wireless technologies such as Radio Frequency (RF) or Infrared. The connected devices may also communicate over a wired network such as Ethernet, power lines, phone lines, etc. The connected devices can communicate with other such devices, with computers, Smartphones, and/or with servers hosted either locally or remotely. A server may be able to receive signals directly from a user via input from a computer, a tablet, a Smartphone, a connected device, or from a third party via input from the same. Communication from the user or from third parties may be secured such that only the user and the third parties given explicit permission can control and communicate with the connected devices belonging to the user. This explicit permission may be granted to other users such as friends and family members, or to companies that provide service by communicating with the user's connected devices. In this way, connected devices may be controlled remotely by the user, by the user's friends and family, by other third party individuals or companies providing a service to the user, etc.

### BRIEF DESCRIPTION OF THE DRAWINGS

FIG. 1 is a schematic block diagram of a system of connected devices, according to an embodiment.

FIG. 2 is a schematic block diagram of a connected device, according to an embodiment.

FIG. 3 is a flowchart illustrating a method of providing access to a connected device, according to an embodiment.

FIG. 4A is a first drawing of an example connected device, according to an embodiment.

FIG. 4B is a second drawing of the example connected device, according to an embodiment.

FIG. 5 is a screen shot of a user interface for controlling a connected device, according to an embodiment.

FIG. 6 is a screen shot of a display of data received from a connected device, according to an embodiment.

FIG. 7 is a flowchart illustrating a method for providing network credentials to a connected device, according to an embodiment.

### DETAILED DESCRIPTION

As used herein the term connected device refers to any electronic device that can communicate with an individual or another electronic device through wired or wireless data transmission.

As used herein the term communications technology refers to any wireless or wired communications protocol that allows for electronic devices to communicate with one another.

As used herein the term third party refers to any party other than the owner of the connected device that might be granted access to the connected device. Third parties may include other users, such as the owner's friends and family, or individuals or companies that provide a product or service to the owner of the connected devices.

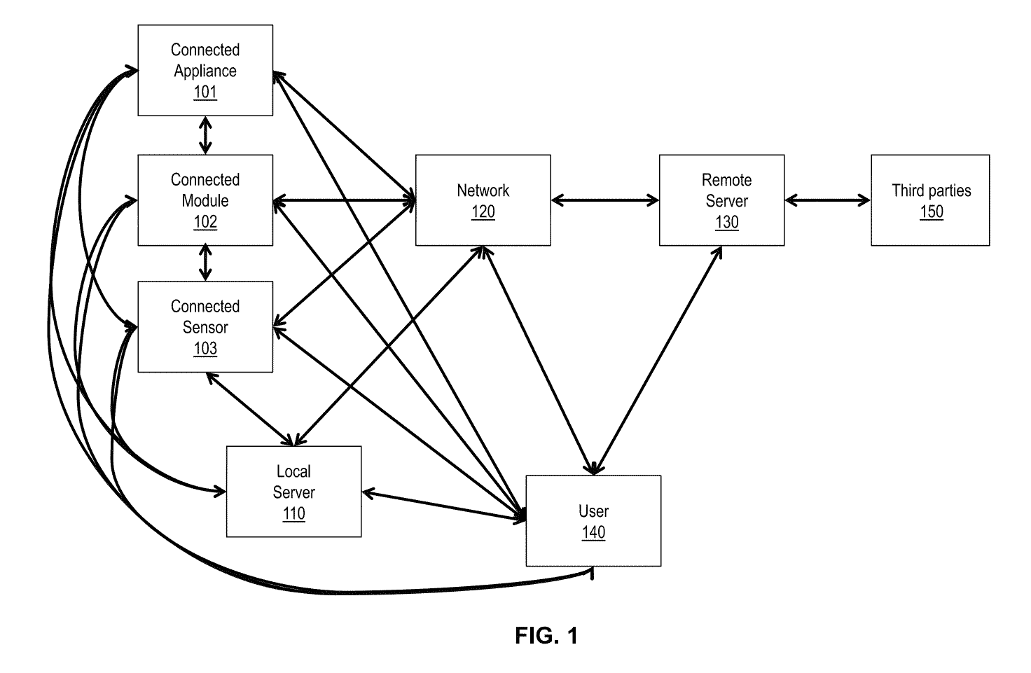

FIG. 1 is a schematic block diagram of a system of connected devices, according to an embodiment. The system of connected devices of FIG. 1 includes multiple connected devices, such as a connected appliance 101, a connected module 102, and a connected sensor 103. Each of these devices can communicate with each other; with a local server 110; directly with a user 140 through a control device such as a Smartphone, a tablet computer, a computer, a key fob, a switch, a button, another input device; and/or with a remote server 130 through a network 120 such as an Internet connection hosted by an Internet Service Provider (ISP). In addition to communicating with the connected devices directly, the user 140 can also communicate with the connected devices through the local server 110, or through the remote server 130. Third parties 150 may communicate with the connected devices through a remote server 130 and then through the network 120.

In some embodiments, a method is provided for gaining access to a connected device (e.g., connected appliance 101) of user 140. The method includes producing a unique identifier such as an Application Programming Interface Key (API Key) or a user Identifier (ID), by a remote server 130. The user may then choose to grant access to an application, for example, provided by third party 150 through the remote server 130, with the third party's API Key user ID. The user can explicitly grant access to the identifier or attempt to run an application provided by the third party 150 in connection with the API Key or user ID, where the user is asked whether the access should be given to the application. If the user grants permission to access one or more of his or her connected devices, then the requests by the application or by the other third party user to communicate with the connected devices can be allowed, and the application or the other third party user can send data to the connected devices, receive data from the connected devices, or control the connected devices. If the user does not grant permission to access his or her connected devices, then the requests to communicate with the connected devices can be blocked by remote server 130.

In some embodiments, a connected device may be an appliance or consumer electronics product that provides a utility to the user. Examples of connected devices may include coffeemakers, toasters, air conditioners, heaters, television sets, cable boxes, lamps, fans, dishwashers, laundry machines, dryers, curling irons, blow dryers, conventional ovens, microwave ovens, water heaters, sump pumps, sprinklers, refrigerators, or other products.

In some embodiments, a connected device may be a sensor that collects data such as temperature, pressure, acceleration, magnetism, sound, video, light, motion, or other data.

In some embodiments, a connected device may be a module that controls a device attached to the connected device, such as a light bulb or an appliance, by interrupting its power supply. For example, the connected device may be a module that sits between the device attached to the connected device and the wall outlet, or between the light bulb and the light bulb socket. The module may activate and deactivate the device attached to the connected device, or it may provide limited power in order to allow for additional functionality, such as dimming a light or slowing a motor.

In some embodiments, a connected device may be a module that serves to improve the functionality of other connected devices, for example, by extending the range of a communication technology or by translating information from one communication technology to another.

In some embodiments, a system of connected devices may track and store data related to a connected device, in order to display the data to the user or to a third party. This data may be data received from a connected device, or it may be data received from a user or a third party with access to a connected device.

In some embodiments, a system of connected devices may receive requests a user or from a third party to be processed at a future date and time. The system may store these communications and relay them to a connected device at a later date or time.

In some embodiments, a connected device may connect to other connected devices, to local servers, or to remote servers using a Transmission Control Protocol (TCP) connection, and communications between the devices and servers may be encrypted with an encryption technology such as Advanced Encryption Standard (AES), RSA algorithm, etc.

In some embodiments, a third party may make requests to the remote server through Hypertext Transfer Protocol (HTTP), where the details of the request may be passed through a Unified Resource Locator (URL), through the HTTP method, or through the body or header of a HTTP request.

In some embodiments, settings of the connected devices, such as frequently-used pre-sets, geographic locations of devices, user account information, or other information may be managed through a web interface or through an application installed on a Smartphone, a tablet computer, or a personal computer.

In some embodiments, inputs to connected devices may be automatically sent from other third party services such as, for example, Twitter, Facebook, Short Message Service (SMS), Instant Messages (IM), or email. These inputs may be used to provide the user with information about events that occur based on the third party services.

In some embodiments, the settings of a connected device may be stored locally on the connected device, and may be modified by the user through a direct connection from a Smartphone, a tablet computer, a personal computer, a remote control, a key fob, or other input devices. These settings may include network credentials such as a Wi-Fi Service Set Identifier (SSID) and a password that may allow the connected device to access a network such as the Internet or a remote server. One connected device that has been provided such information and settings may be able to connect directly to another connected device in order to share such information and settings.

In some embodiments, a connected device may be controlled manually by direct intervention by the user via a physical input such as a button or a switch. The device may send information regarding this manual control to a local server or a remote server over a network.

In some embodiments, a connected device may have a unique identifier that is a series of legible words and/or characters. This unique identifier may be printed on the connected device or its packaging, and the unique identifier may be used to set up the connected device, to connect the connected device to a system of connected devices, to inform a remote server that the connected device belongs to a certain user, to provide third parties permission to access the connected device, or other functions.

In some embodiments, a connected device can have a variable design element such as a colored LED that can be associated with the graphical user interface (GUI) so that devices can be easily identified and distinguished. As an example, one connected device can have an LED that shines blue, and its icon on the GUI can also be blue. Another connected device can have an LED that shines red, and its icon on the GUI can also be red. This distinction can allow the user to easily identify which device is connected to which GUI element.

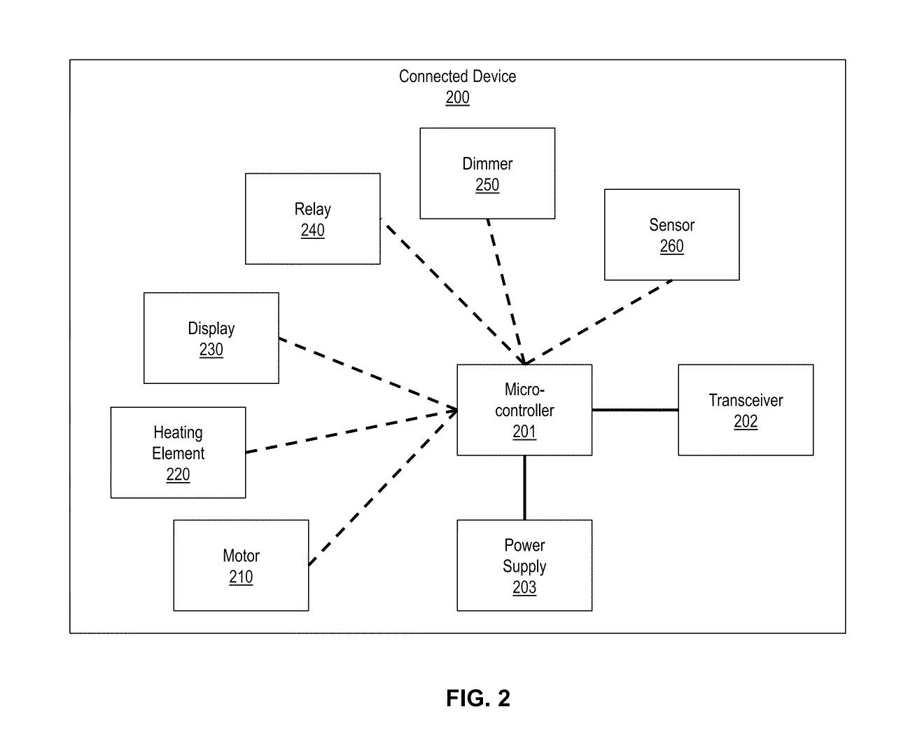

FIG. 2 is a schematic block diagram of a connected device, according to an embodiment. The connected device of FIG. 2 may include a micro-controller 201 that houses the code and logic of the device, a transceiver 202 to facilitate communications, and a power supply 203 to provide power to the device. The micro-controller may be connected to a number of inputs and outputs, such as a motor 210, a heating element 220, a display 230, a relay 240 to control power to another device or component, a dimmer 250 to control power to another device or component, or a sensor 260 that may receive inputs from the user, from other people, or from the environment. As an example, when a connected device 200 is connected to a power source through the power supply 203, the device may activate. The micro-controller 201 may instruct the transceiver 202 to connect to a communications network (not shown in FIG. 2). When such a connection has been established, the micro-controller may relay information from a sensor 260 to the network through the transceiver 202. The micro-controller may also wait for a signal from the network via transceiver 202, and when it receives a signal it may activate, deactivate, or change the settings on a dimmer 250, relay 240, display 230, heating element 220, or motor 210. The micro-controller can then measure the results of such a change and can relay the results back to the network via the transceiver 202.

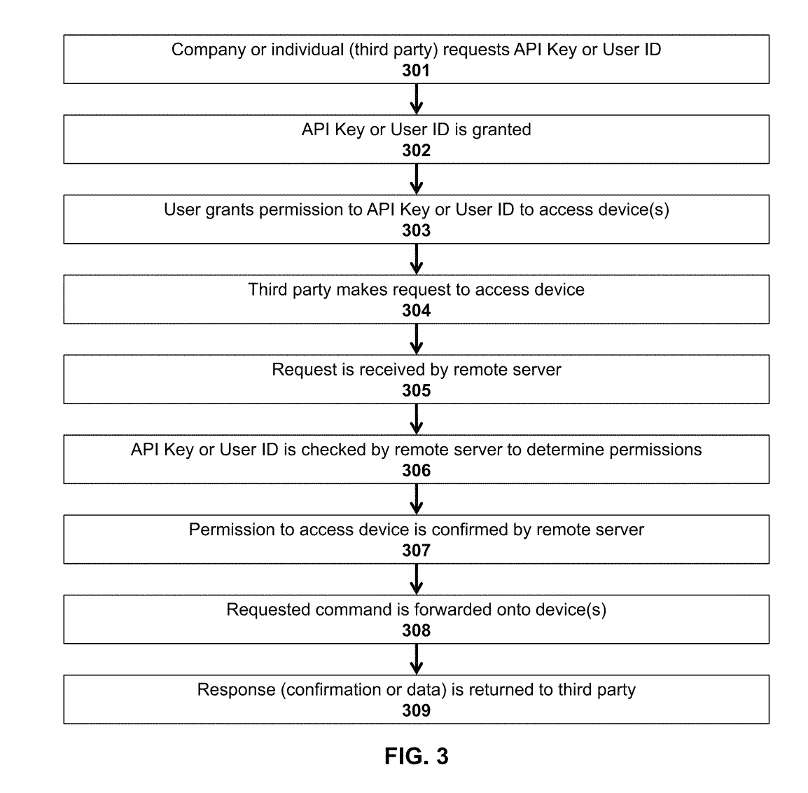

FIG. 3 is a flowchart illustrating a method of providing access to a connected device, according to an embodiment. The description of the flow-chart references elements shown in FIG. 1. For a third party 150 to access any connected devices in the system, at 301, the third party 150 requests a unique identifier such as an API Key or a User ID from the remote server 130. That API Key or User ID is granted by the remote server 130 at 302, at which point the third party 150 may publish the unique identifier either explicitly or hidden within a user interface. At 303, the user 140 can grant permission to the API Key or User ID to allow access to one or more of his or her connected devices (e.g., connected appliance 101). For example, the user 140 may explicitly request that this third party 150 can have access or can grant access after being prompted. At 304, the third party 150 makes a request to access the device. At 305, the remote server 130 receives the request. The remote server 130 can then check the API Key or User ID to determine whether that third party 150 has been granted access to control the requested device(s), at 306. If the third party 150 is granted permission by the user 140, at 307 the remote server 130 can confirm the permission at 307, and at 308 forwards the command on to the device(s) through the network 120. The remote server 130 can then await a response from the device(s), and when such a response is received, it is returned to the third party 150, at 309.

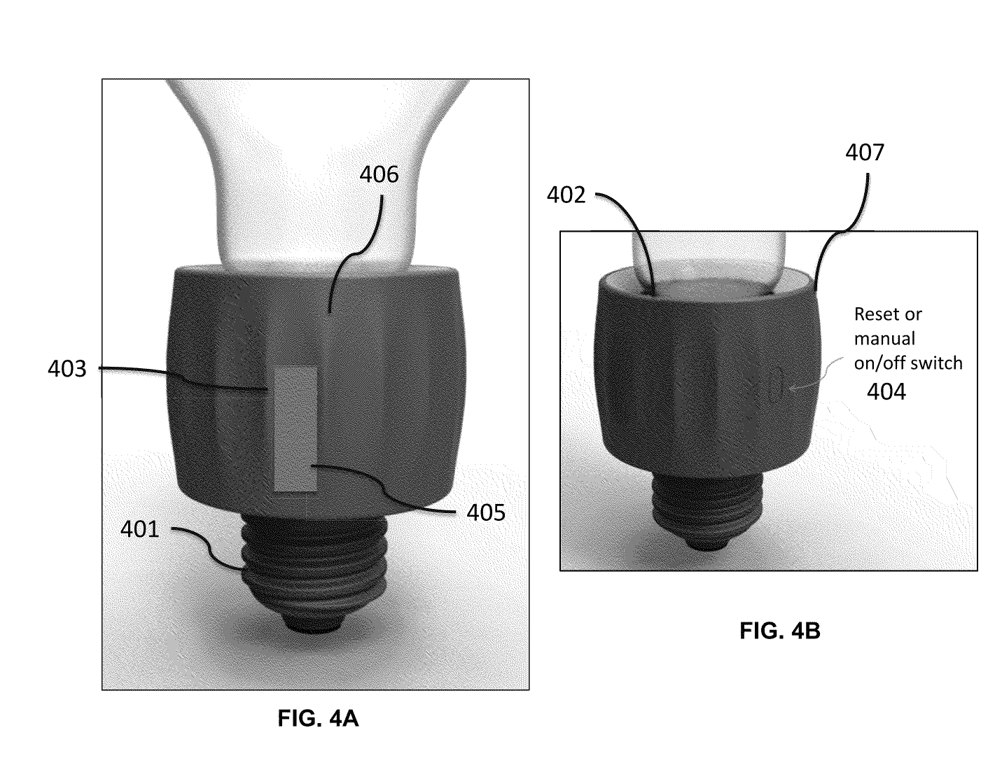

FIGS. 4A and 4B provide drawing views of an example connected device, according to an embodiment. The connected device of FIGS. 4A and 4B may include a male Edison screw 401 for attaching to a light bulb socket; a female Edison screw 402 for accepting a light bulb (obscured); an indicator LED (not shown in FIGS. 4A and 4B) to provide feedback to the user (obscured); a button 404 for manual control of the connected device (obscured); a logo, a trade name, a product name, or other brand identity (not shown in FIGS. 4A and 4B); a textured design to aid in screwing and unscrewing the device 406; a bright color in a partially obstructed location on the product 407, etc. As an example, a user may plug the device into a lamp socket using the male Edison screw 401, and then screw a light bulb into the female Edison screw 402. The device may then receive power through the power supply 203, activating the micro-controller 201 and the transceiver 202 (shown in FIG. 2). The micro-controller 201 can instruct the transceiver 202 to connect to a local network, and provide feedback on the status of the device to the user via the LED status light (not shown in FIGS. 4A and 4B). Power to the light bulb can be controlled through a relay 240 and/or a dimmer 250.

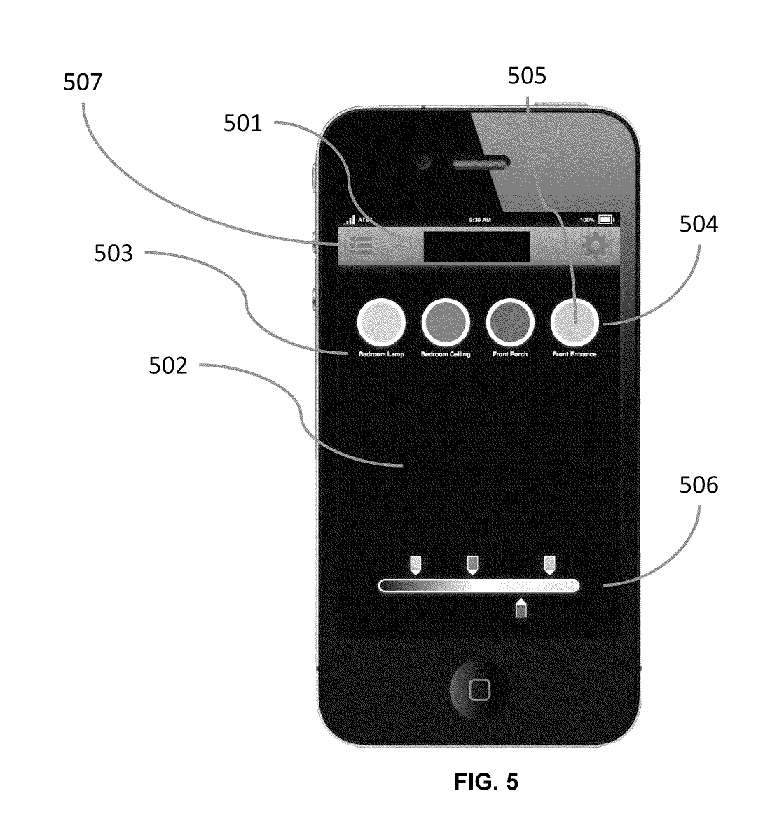

FIG. 5 is a screen shot of an example user interface for controlling a connected device, according to an embodiment. The user interface of FIG. 5 may include a logo, a trade name, a product name, other brand identity (not shown in FIG. 5); an area of the screen dedicated to the control of a connected device 502; a description of the device 503; one or more buttons that provide aspects of control over the device(s) 504; a colored area to identify the device 505; a slider that may provide analog control over the device along some axis such as dimming 506; a menu to provide other options 507.

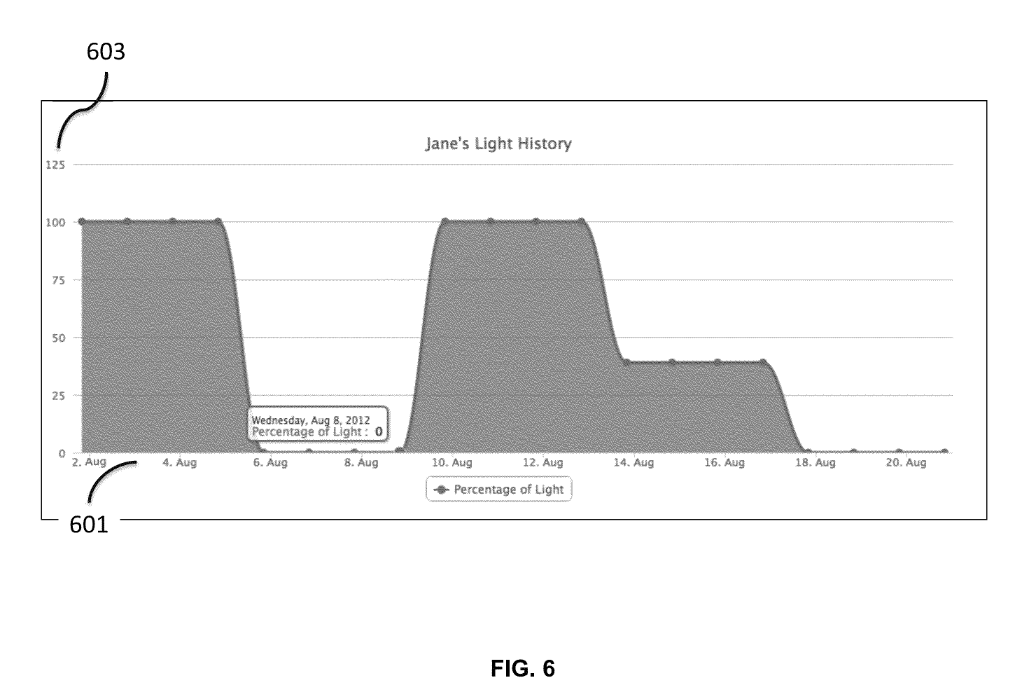

FIG. 6 is a screen shot of a display of data received from a connected device, according to an embodiment. The data may include a graph with an axis for date and time 603 and another axis for some data provided from the connected device 601; data displayed on the two axes. As an example, FIG. 6 represents a graph showing light generated from a bulb over time; between August 2 and August 6, the light is on at full power (100%), and between August 6 and August 9, the light is off (0% power). Between August 14 and August 18, the light is dimmed to 40% power. This graph can be used by the user to understand his or her lighting and energy consumption, and to change his or her behavior with regards to how he or she uses this and other lights.

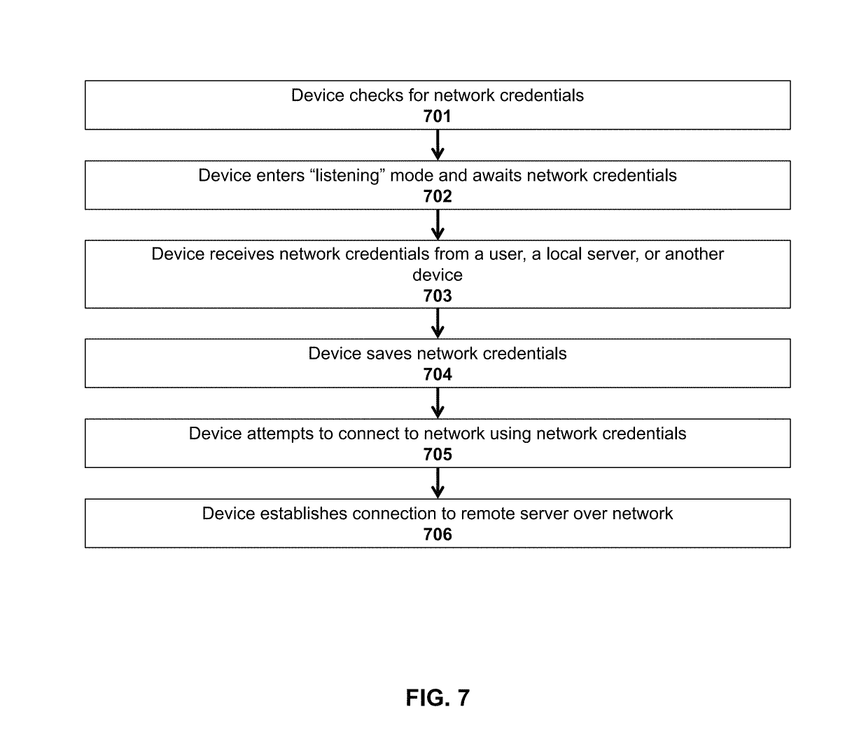

FIG. 7 is a flowchart illustrating a method for providing network credentials to a connected device (e.g., a connected appliance, light, etc.), according to an embodiment. At 701, the device (e.g., the micro-controller 201 within the device 200 of FIG. 2) first checks for network credentials stored locally at a memory at the device. If the device does not find locally stored network credentials, or finds network credentials that do not allow the device to successfully connect to a network, at 702, the device enters a listening mode via the transceiver 202 (see FIG. 2) and awaits network credentials to be sent to the device from the user 140 or from another device (e.g., connected appliance 101, see FIG. 1). The network credentials may be sent over any wired or wireless communications technology such as IEEE 802.11 (“Wi-Fi”), IEEE 802.15.4, Radio Frequency (RF), infrared, sound waves, Ethernet, power lines, phone lines, etc. At 703, the device receives network credentials from a user 140, a local server 110, or from another device. At this point, at 704, the device saves the network credentials locally on a medium such as a Flash drive, an Electrically Erasable Programmable Read-Only Memory (EEPROM), on punch cards, etc. The device can then attempt, at 705, to connect to the network 120 using the saved network credentials via the transceiver 202. If the device is successfully connected to the network 120, at 706, the device establishes a connection to the remote server 130 over the network 120.

Some embodiments described herein relate to devices (e.g., access points, mobile communication devices) with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described. For example, a connected device (e.g., connected appliance 101) may communicate with a local server 110, which is in turn connected to the network 120, and communicates with the remote server 130; in this example, communications from the remote server 130 may be sent to the connected device through the local server 110 rather than directly over the network 120.

In another example, the user may connect directly to the network 120, to the local server 110, or to the connected device, rather than communicating with the connected device through the remote server 130.

In another example, the connected devices 101, 102 and 103 may communicate directly with each other, rather than over the network 120.

In another example, API Keys and User IDs may be granted at 302, received at 305, and checked at 306 by the local server 110 rather than the remote server 130.

In another example, API Keys and User IDs may be granted at 304, received at 305, and checked at 306 by the connected device rather than the remote server 130.

1. (canceled)

2. A method performed by a server for interaction with a controllable device, comprising operations performed with a processor and memory of the server, the operations including:
receiving a request to perform a command upon the controllable device, the request accompanied by a unique identifier, wherein the command is used to initiate an electromechanical operation of the controllable device, and wherein the request is in a different format than the command;
attempting validation of the unique identifier to determine whether the unique identifier is associated with permission to access the controllable device;
responsive to successful validation of the unique identifier, forwarding the command from the server to the controllable device; and
providing a response to the request to perform the command upon the controllable device;
wherein the command results in control of the electromechanical operation of the controllable device by execution of the command with a microcontroller of the controllable device; and
wherein the server is communicatively coupled to the controllable device using a connection over a wide area network, wherein the server is accessible by an interface via the wide area network to receive the request to perform the command upon the controllable device, and wherein the controllable device is not accessible by any interface via the wide area network to receive the request to perform the command.

3. The method of claim 2, the operations including establishing permission to access the controllable device using the unique identifier prior to successful validation of the unique identifier, including:
receiving an access grant from an owner of the controllable device to enable a third party to have access to the controllable device via use of the unique identifier by the third party; and
associating the unique identifier with permission to access the controllable device.

4. The method of claim 3,
wherein the interface via the wide area network to receive the request is an application programming interface, wherein the application programming interface is configured for receiving the request to perform the command upon the controllable device from a third party, wherein the application programming interface is used to trigger forwarding the command to the controllable device upon successful validation of the unique identifier, and wherein the unique identifier is an application programming interface key; and
wherein the request is received by the application programming interface via a Hypertext Transfer Protocol (HTTP) communication, and wherein details of the request are passed through a Unified Resource Locator (URL), through an HTTP method, or through a body or a header of an HTTP request, received with the HTTP communication.

5. The method of claim 2, wherein the command to perform upon the controllable device is forwarded from the server to a local server, for forwarding the command from the local server to the controllable device, wherein the local server is communicatively coupled to the controllable device via a wireless local area network, and wherein the local server is communicatively coupled to the server via the wide area network.

6. The method of claim 2,
wherein the controllable device is configured for establishing a connection to the server over the wide area network to communicate a status of the execution of the command upon the controllable device; and
wherein the controllable device is configured for establishing the connection to the server using a set of credentials for communication with a wireless local area network used to access to the wide area network.

7. The method of claim 6,
wherein the controllable device is a connected appliance, a connected module, or a connected sensor; and
wherein the command is used to retrieve a data value from the microcontroller of the connected device, the data value being communicated from the controllable device to the server in the status of the execution of the command upon the controllable device, and the data value being included in the response to the request to perform the command.

8. The method of claim 2, wherein the microcontroller of the controllable device is coupled to at least one control element, the control element providing control for one or more of a motor, a heating element, a display, a relay, or a dimmer, and wherein the microcontroller is configured to receive the command from the server to effect a change of the control element.

9. A non-transitory computer readable medium that stores instructions, which when performed by a computer, cause the computer to perform operations to control access and interaction with a controllable device, with operations that:
receive a request to access and perform a command upon the controllable device, the request accompanied by a unique identifier, wherein the request is associated with an electromechanical operation upon the controllable device;
attempt validation of the unique identifier to determine whether the unique identifier is associated with permission to access the controllable device;
responsive to successful validation of the unique identifier, forward the command from the computer to the controllable device; and
provide a response to the request to access and perform a command upon the controllable device;
wherein the computer is communicatively coupled to the controllable device using a connection over a wide area network;
wherein the command is used to facilitate the electromechanical operation of the controllable device with an execution of logic upon a microcontroller of the controllable device; and
wherein the request is received by the computer via a Hypertext Transfer Protocol (HTTP) communication, and wherein the command and the unique identifier is received through a Unified Resource Locator (URL), through an HTTP method, or through a body or a header of an HTTP request, provided with the HTTP communication.

10. The non-transitory computer readable medium of claim 9, comprising instructions, which when performed by the computer, cause the computer to perform operations to establish permission for the unique identifier, including operations that:
receive an access request from an owner of the controllable device to grant a third party with permission to access the controllable device for performance of the command via use of the unique identifier by the third party; and
establish the unique identifier with permission to access the controllable device for performance of the command;
wherein the unique identifier is an application programming interface key or a user identifier, the unique identifier being associated with the third party.

11. The non-transitory computer readable medium of claim 10,
wherein the computer hosts an application programming interface accessible via the Hypertext Transfer Protocol (HTTP) communication, the application programming interface used for receiving the request to access and perform a command upon the controllable device from the third party; and
wherein the request to perform a command upon the controllable device is used to trigger transmission of the command to the controllable device after successful validation of the unique identifier for permissions granted for the third party, and wherein the unique identifier is an application programming interface key.

12. The non-transitory computer readable medium of claim 11, wherein the computer is configured to verify permission of the third party to perform a particular type of command upon the controllable device with validation of the application programming interface key received via the application programming interface.

13. The non-transitory computer readable medium of claim 9, wherein the request to perform a command upon the controllable device is forwarded to a local server, for forwarding the command from the local server to the controllable device, wherein the local server is communicatively coupled to the controllable device via a wireless local area network, and wherein the local server is communicatively coupled to the computer via the wide area network.

14. The non-transitory computer readable medium of claim 13, wherein the controllable device is configured to receive network credentials from the local server for communication via the wireless local area network, the network credentials used for communicating, to the computer, a status of the request to perform the command upon the controllable device, wherein the status of the request to perform the command includes a data value obtained from the controllable device.

15. The non-transitory computer readable medium of claim 9, wherein the computer is configured to receive data resulting from one or more events that occur at the connected device, by receiving data communicated directly from the connected device to the computer.

16. The non-transitory computer readable medium of claim 9, wherein the controllable device is a connected appliance or a connected module, and wherein the command causes control of a component of the controllable device, the component being one or more of: a motor, a heating element, a display, a relay, or a dimmer.

17. A connected device control system, comprising:
a connected device configured for performing an home automation function, the connected device including a transceiver configured to receive wireless communications and a microcontroller configured to perform the home automation function via control of an electromechanical component, the transceiver configured to receive an automation command to effect control of the electromechanical component, and the microcontroller configured to perform the automation command to effect control of the electromechanical component;
wherein the remote server includes a processor and memory, wherein the remote server is configured to forward the automation command to the connected device in response to a request associated with the automation command that is received via an application programming interface, the remote server configured to forward the automation command upon successful validation of a unique identifier received via the application programming interface; and
wherein the unique identifier is associated with authorization to access the connected device and perform a particular command type upon the connected device according to a set of permissions accessible by the remote server.

18. The connected device control system of claim 17, wherein the connected device is configured to communicate data from one or more events that occur at the connected device, by communicating data directly from the connected device to the remote server.

19. The connected device control system of claim 17, wherein the remote server is configured to verify permission of a third party to access the connected device with validation of the unique identifier associated with the third party received via the application programming interface.

20. The connected device control system of claim 17, wherein the electromechanical component includes one or more of: a motor, a heating element, a display, a relay, a dimmer, or a sensor.

21. The connected device control system of claim 17, comprising a local server configured for wireless communication with the connected device via a wireless local area network, the local server including a processor and memory, wherein the local server is configured to receive the automation command to control the electromechanical component from the remote server, wherein the local server is configured to forward the automation command to the connected device via the wireless local area network, and wherein the local server is connected to the remote server via a wide area network;
wherein the remote server is configured to forward the automation command to the connected device via the local server in response to the request associated with the automation command that is received via the application programming interface;
wherein the connected device is configured to receive network credentials from the local server for communicating via the wireless local area network;
wherein the connected device is configured to communicate data from one or more events that occur at the connected device, by communicating data from the connected device to the local server for communication to the remote server; and
wherein the connected device is configured to provide a response to the automation command to the local server, and wherein the local server is configured to provide the response to the automation command to the remote server.
